(19) United States
(12) Patent Application Publication
(10) Pub. No.: US 2018/0256438 A1
(43) Pub. Date: Sep. 13, 2018

(54) CHIN MASSAGE DEVICE

(71) Applicant: Steve Chalkias, Maple Ridge (CA)

(72) Inventor: Steve Chalkias, Maple Ridge (CA)

(21) Appl. No.: 15/452,245

(22) Filed: Mar. 7, 2017

(51) Int. Cl. A61H 7/00

(52) U.S. Cl. CPC A61H 7/004; A61H 2205/02; A61H 2201/1207

(57) ABSTRACT

A chin massage device is disclosed including a flexible belt arranged to manipulate the internal tissues of an under-chin area by externally engaging the under-chin area of a user, a reciprocating-belt mover arranged to move the flexible belt in forward and reverse directions during external engagement of the under-chin area via the flexible belt, an electrically-powered driver arranged to drive the reciprocating-belt mover, and a support frame arranged to support the flexible belt, the reciprocating-belt mover, and the electrically-powered driver in an operable relationship, the support frame having a base portion arranged to stabilize the support frame on a supportive surface during use.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of exercise devices for the head or neck of existing art and more specifically relates to massage devices for the head or neck.

### 2. Description of Related Art

Fat accumulation under the chin is a common phenomenon. Dieting and exercise are often used to reduce body fat; however, many individuals find the area around the neck to be particularly resistant to these fat reduction measures. Persons wishing to restore firmness to their chin and neck area may resort to surgical procedures, liposuction being the primary method. Such surgical procedures are expensive and hold many inherent risks. A need exists for inexpensive, simple to use, and non-invasive techniques for treatment of fat accumulation under the chin. Such techniques and apparatus should adapt to all types and sizes of heads, should also be comfortable, easy to maintain, clean, and should be durable.

Attempts have been made to solve the above-mentioned problem such as those found in U.S. Pat. No. 2,691,978 to Kirby, which describes a device for use in reducing the chin and for lifting the contour of the face. The described device relates to removing excess fatty tissue from the chin, particularly below the chin and for lifting the contour of the face or elevating dropping facial tissue. One of the objects of the invention is the provision of a simple, manually manipulatable pair of rollers so shaped and so arranged relative to each other, particularly with respect to their axes of rotation, that they may be simultaneously rolled along opposite sides of the chin line from the point of the chin to the ears, to simultaneously effect a reduction of the accumulated surplus fatty tissue below the chin and lower jaw, and a lifting of the tissue above the chin line as well as a forcing of such tissue and the skin in a direction away from the corners of the mouth.

### BRIEF SUMMARY OF THE INVENTION

In view of the foregoing disadvantages inherent in the known massage devices for the head or neck art, the present disclosure provides a novel chin massage device. The general purpose of the present disclosure, which will be described subsequently in greater detail, is to provide a chin massage device.

According to an embodiment of the present disclosure, a chin massage device is disclosed herein. The chin massage device includes a flexible belt arranged to manipulate the internal tissues of an under-chin area by externally engaging the under-chin area of a user, a reciprocating-belt mover arranged to move the flexible belt in forward and reverse directions during external engagement of the under-chin area via the flexible belt, an electrically-powered driver arranged to drive the reciprocating-belt mover, and a support frame arranged to support the flexible belt, the reciprocating-belt mover, and the electrically-powered driver in an operable relationship, the support frame having a base portion arranged to stabilize the support frame on a supportive surface during use.

Moreover, it provides such a chin massage device wherein the reciprocating-belt mover is arranged to move the flexible belt a distance of at least one inch. Additionally, it provides such a chin massage device wherein the reciprocating-belt mover includes a set of guide rollers arranged to supportively guide the flexible belt during the movement. Also, it provides such a chin massage device further comprising a belt tensioner arranged to maintain the tension of the belt above a preset level. In addition, it provides such a chin massage device wherein each guide roller includes a shaft engaging the support frame, and the chin massage device includes at least one friction-reducing bearing arranged to reduce rolling resistance of the guide roller.

The support frame includes an outer housing structured and arranged to protectively house the guide rollers and portions of the flexible belt out of contact with the under-chin area of the user. The support frame includes at least one height adjuster to assist user adjustment of the flexible belt to a user-preferred height relative to the supportive surface. The support frame may include at least one belt-length adjuster arranged to assist user adjustments to the length of a segment of the flexible belt available to externally engage the under-chin area of the user. Even further, it provides such a chin massage device wherein the belt includes a transverse width of at least one inch. The electrically-powered driver may include a reversible direct-current electric motor. The flexible belt may be engaged on a set of guide rollers, and the reversible direct-current electric motor is arranged move the flexible belt by rotating at least one guide roller of the set. Even further, it provides such a chin massage device wherein the reversible direct-current electric motor is a stepping-type electric motor.

In addition, it provides such a chin massage device further comprising a micro-controller arranged to control the operation of the stepping-type electric motor. The micro-controller may include at least one user control arranged to allow the user to control at least one operational parameter of the stepping-type electric motor. Moreover, it provides such a chin massage device wherein the micro-controller may include at least one user-discernable indicator arranged to indicate at least one operational parameter of the chin massage device. Even further, it provides such a chin massage device further comprising at least one low-voltage power supply. Furthermore, it provides such a chin massage device wherein the at least one low-voltage power supply includes at least one on-board rechargeable battery. Even further, the at least one low-voltage power supply may be arranged to convert line-voltage alternating current to low voltage direct current.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a chin massage device, constructed and operative according to the teachings of the present disclosure.

FIG. 1 is a perspective view of the chin massage device, according to an embodiment of the disclosure.

FIG. 2 is a front view of the chin massage device during an ‘in-use’ condition, according to an embodiment of the disclosure.

FIG. 3 is a front view, enlarged for clarity, of the chin massage device of FIG. 1, according to an embodiment of the present disclosure.

FIG. 4 is a diagrammatic sectional view through the section 4-4 of FIG. 1, showing internal arrangements of the chin massage device of FIG. 1, according to an embodiment of the present disclosure.

FIG. 5 is a perspective view of guide roller of the chin massage device, according to an embodiment of the disclosure.

FIG. 6 is a diagrammatic sectional view showing the guide roller of the chin massage device of FIG. 1, according to an embodiment of the present disclosure.

FIG. 7 is a is a schematic diagram, illustrating control features of the chin massage device of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a massage devices for the head or neck and more particularly to a chin massage device as used to improve the manipulation of internal tissues of an under-chin area of a user.

Generally, this device is used to reduce the fat deposits under the chin area. A smooth, non-abrasive belt under tension is configured to roll back and form stimulating the area to promote reductions of fat. The belt may be constructed from a light duty but durable rubber. The belt may have some flex and may be between one inch and four inches wide. The belt may have a smooth non-irritating surface. Versions of the device are size adjustable to fit multiple users. The belt is supported on rollers, which may be metal sleeves with a rubber surface. The rollers may include bearings for smooth long-lasting action.

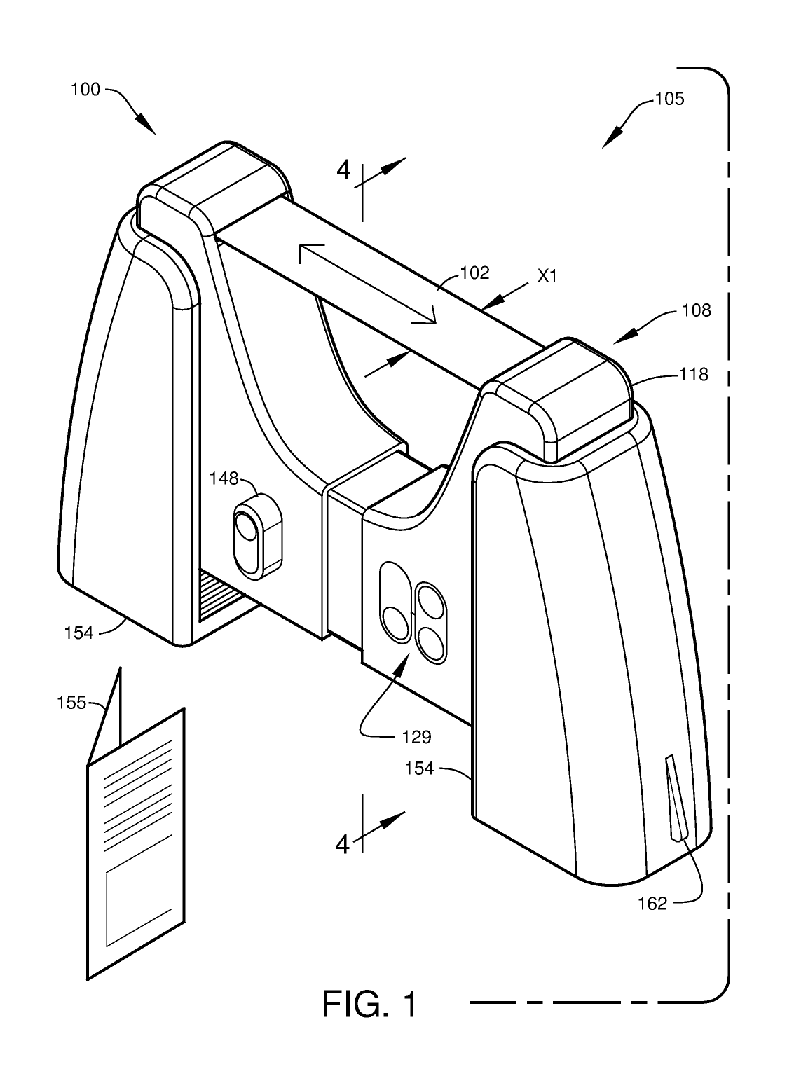

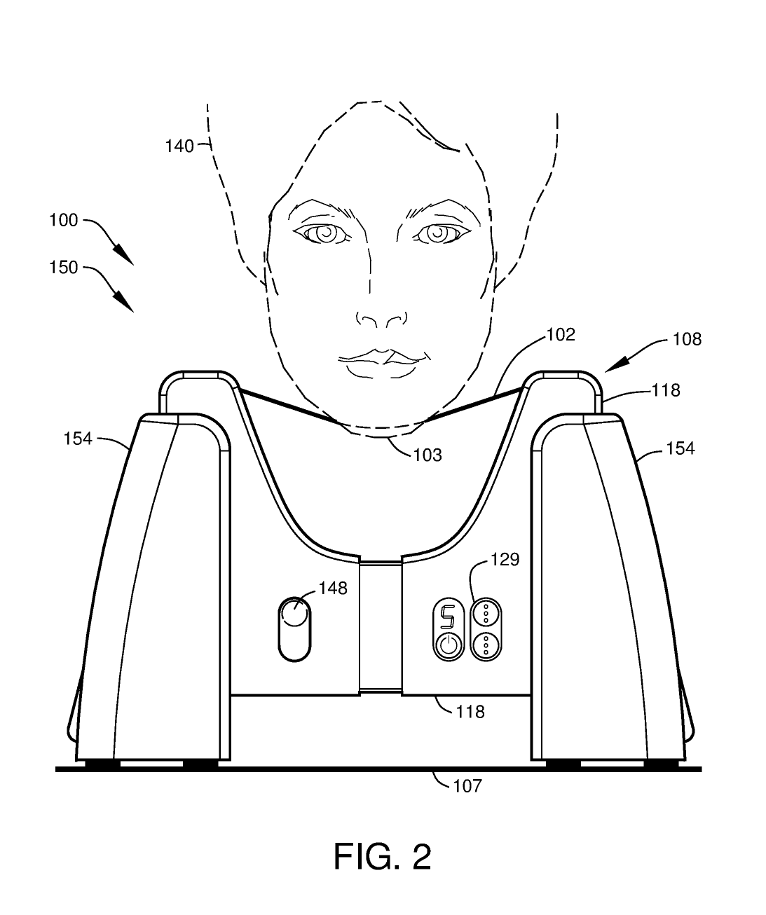

The various embodiments of the present invention will hereinafter be described in conjunction with the appended drawings, wherein like designations denote like elements. Referring now more specifically to the drawings by numerals of reference, there is shown in FIGS. 1-7, various views of a chin massage device 100. FIG. 1 is a perspective view showing the chin massage device 100, according to an embodiment of the present disclosure. FIG. 2 is a front view of the chin massage device 100 during an ‘in-use’ condition 150, according to an embodiment of the disclosure. The chin massage device may be beneficial for use by a user 140 to manipulate internal tissues of the under-chin area 103 of the user 140. The disclosed device may assist the user 140 in improving the overall appearance of the jawline.

As illustrated, the chin massage device 100 utilizes a flexible belt 102 to manipulate the internal adipose tissues (fat tissues) of the under-chin area 103 by externally engaging the under-chin area 103 of the user 140. The flexible belt 102 is configured to move in forward and reverse directions (as indicated by the arrow depiction) during the engagement of the under-chin area 103. The belt 102 may have a transverse width Xl of at least about one inch. Versions of the device may be supplied with belt widths Xl ranging between about one inch and about four inches. Preferred belt materials are flexible and may have a smooth non-irritating surface. The belt may be constructed from a lightweight but durable natural or synthetic polymer having elastic properties, e.g., rubber-like materials. Some polymers suitable for use in the present device include polyisoprene or natural rubber, silicone, polybutadiene, polyisobutylene, and polyurethanes. Upon reading this specification, it should be appreciated that, under appropriate circumstances, considering such issues as user preferences, design preference, marketing preferences, cost, etc., other belt configurations such as, for example, narrower or wider belts, the use of other materials such as wool or other materials composed of natural fibers, etc., may be sufficient

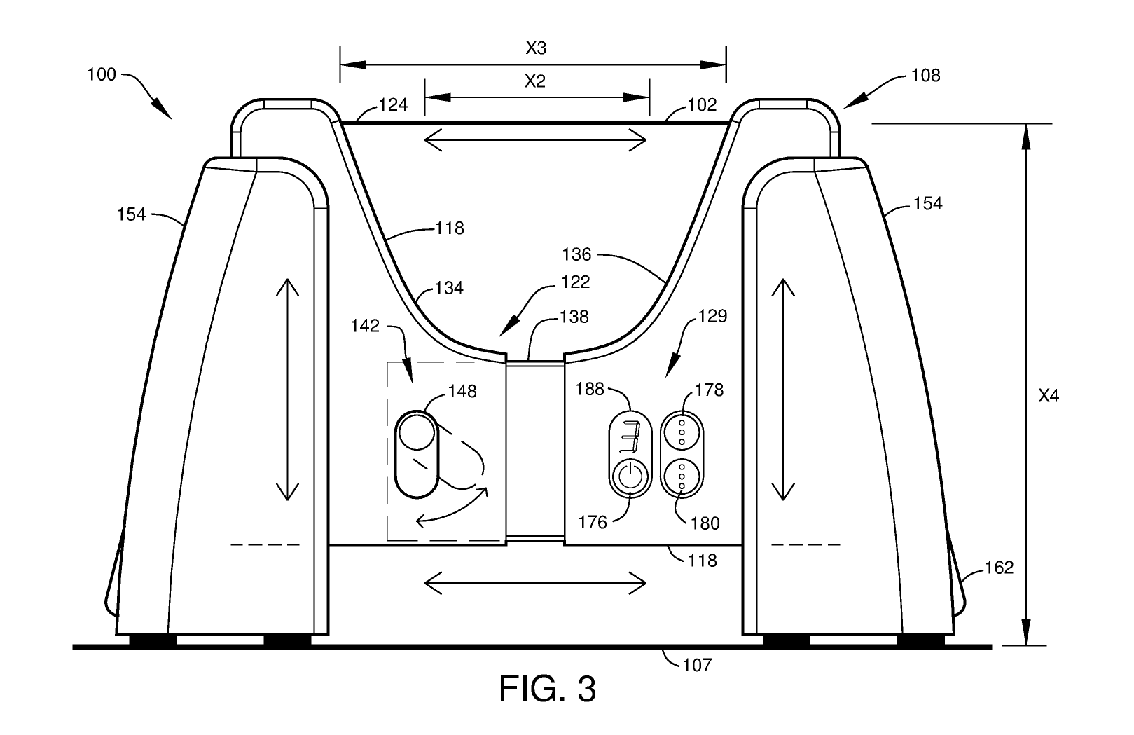

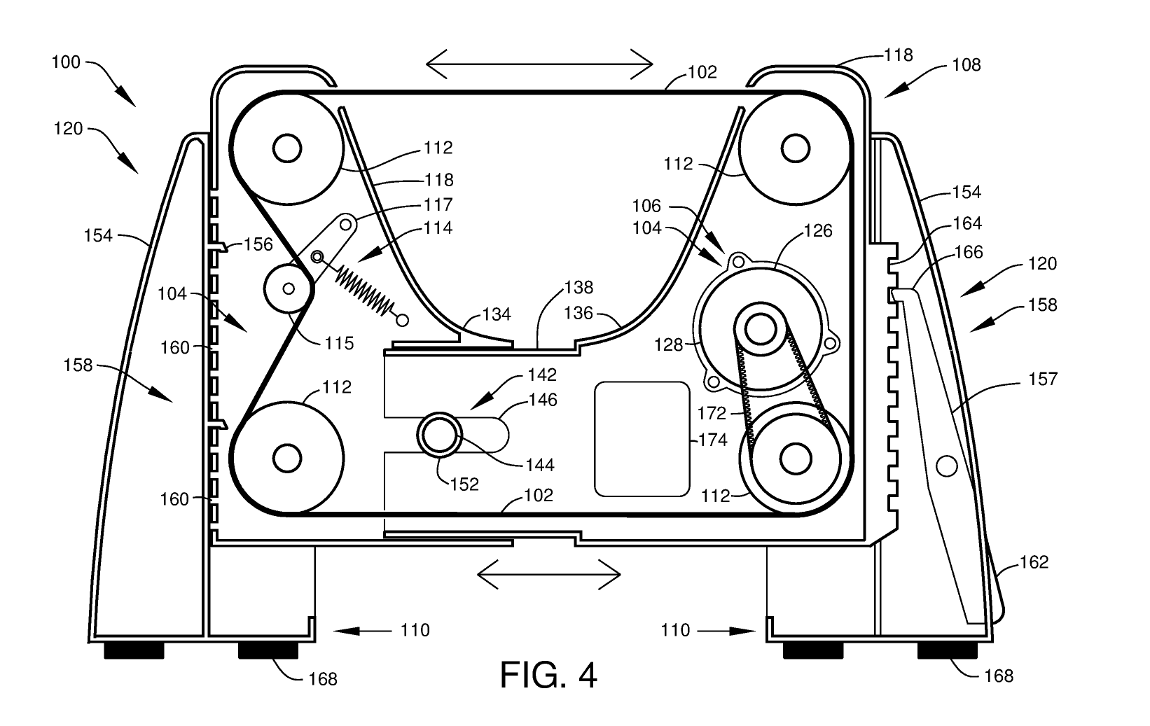

FIG. 3 is a front view, enlarged for clarity, of the chin massage device 100 of FIG. 1, according to an embodiment of the present disclosure. FIG. 4 is a diagrammatic sectional view through the section 4-4 of FIG. 1, showing internal arrangements of the chin massage device 100. Referring to sectional view of FIG. 4, the flexible belt 102 may be formed as a single continuous loop, as shown. Alternately, the flexible belt 102 may include one or more couplers (not shown) to facilitate installation and removal.

The flexible belt 102 is supported by a reciprocating-belt mover generally identified in the present disclosure as belt mover assembly 104. The belt mover assembly 104 is configured to move the flexible belt 102 in forward and reverse directions during external engagement of the under-chin area 103 (see also FIG. 2). The belt mover assembly 104 is configured to move the flexible belt 102 a distance X2 of between about one inch and about five inches.

The belt mover assembly 104 may include a set of guide rollers 112 arranged to supportively guide the flexible belt 102 during the belt movement. In the depicted device, the flexible belt 102 is supported by four primary guide rollers 112, with two located at the base of the assembly and two located near the upper portion of the assembly, as shown. A belt tensioner 114 may also be provided to maintain the tension of the belt 102 above a preset level. The belt tensioner 114 may include an additional roller 115 supported on a spring-loaded armature 117, as shown. The tension of the belt may be adjustable in some embodiments.

The belt mover assembly 104 may include an electrically-powered driver 106 configured to drive the forward and reverse movement of the belt 102. The electrically-powered driver 106 may be an electric motor, more specifically, a reversible direct-current electric motor 126, as described in greater detail below. Upon reading this specification, it should be appreciated that, under appropriate circumstances, considering such issues as user preferences, design preference, structural requirements, marketing preferences, cost, available materials, technological advances, etc., other belt moving arrangements such as, for example, linear actuators, solenoids, pivoting arms, scotch-yoke mechanisms, Whitworth quick-return mechanisms, rack and pinions, etc., may be sufficient.

A support frame 108 is provided to support the flexible belt 102, the belt mover assembly 104, and the electrically-powered driver 106 in an operable relationship. In preferred embodiments of the present disclosure, the support frame 108 may form an outer housing 118 arranged to protectively surround the guide rollers 112 and portions of the flexible belt 102 out of contact with the under-chin area 103 of the user 140. Note that the upper guide rollers 112 are fully enclosed within the outer housing 118. In preferred embodiments of the present disclosure, the support frame 108 may be constructed from a rigid and durable plastic.

The support frame 108 may include a belt-length adjuster 122 arranged to assist user adjustments to the length X3 of a segment 124 of the flexible belt 102 available to externally engage the under-chin area 103 of the user 140 (see also FIG. 2). In the depicted embodiment, the belt-length adjuster 122 is implemented by forming the outer housing 118 in two parts. For example, the outer housing 118 may include a left-side portion 134 and a right-side portion 136, as shown. The left-side portion 134 may be configured to receive an extension 138 of the right-side portion 136 with a snug but slidable, telescoping fit. The extension 138 of the right-side portion 136 comprises a length that permits the user 140 to slidably adjust the distance relationship between the left-side portion 134 and the right-side portion 136. In this arrangement, the length X3 of the segment 124 is adjusted by altering the distance relationship between the left-side portion 134 and the right-side portion 136.

In addition, the belt-length adjuster 122 may be fitted with a locking mechanism 142 enabling the left-side portion 134 and the right-side portion 136 to be releasably secured together in nested telescoping relation. The locking mechanism 142 may include a threaded shaft 144 projecting transversely from a first side of the outer housing 118, through a linear slot 146 in the extension 138, passing through a second side of the outer housing 118. A threaded clamping lever 148 (see FIG. 3) may be engaged on the threaded shaft 144 to allow the user 140 to lock the left-side portion 134 and the right-side portion 136 in a selected distance relationship by establishing a clamping force between the parts. A threaded-shaft sleeve 152 (or a set of transverse reinforcements) may be provided, as required, to control the clamping force and optimize and operation of the locking mechanism 142. Upon reading this specification, it should be appreciated that, under appropriate circumstances, considering such issues as user preferences, design preference, structural requirements, marketing preferences, cost, available materials, technological advances, etc., other width adjustment and locking arrangements such as, for example, housing pivots, cam locks, detent/aperture locks, snap-lock positioners, etc., may be sufficient.

The chin massage device 100 may further include a height adjuster 120 arranged to assist the user 140 in adjusting the flexible belt 102 to a user-preferred height X4 relative to a supportive surface 107. The height X4 may be adjustable between about 8 inches and 12 inches. Upon reading this specification, it should be appreciated that, under appropriate circumstances, considering such issues as user preferences, design preference, structural requirements, marketing preferences, cost, available materials, technological advances, etc., other adjustment arrangements such as, for example, lower unit heights, taller unit heights, floor-supported units, etc., may be sufficient.

In the depicted embodiment, the height adjuster 120 is implemented using a pair of adjustable legs 154 that are movably-engaged on opposing sides of the support frame 108/outer housing 118. Each adjustable leg 154 is configured to allow the member to move up and down relative to the housing and be locked in place at a user-selected position. The sectional view of FIG. 4 shows two different example interlocking features 158. The left adjustable leg 154 includes a set of projecting tabs 156 that are configured to removably engage a set of spaced apart sockets 160 using a “snap-together” coupling arrangement. The user may adjust the height of the assembly by snapping the adjustable leg 154 away from the side of the outer housing 118 followed by reinstallation the adjustable leg 154 at a new position on the outer housing 118, again using a snap-type engagement of the tabs and sockets.

The right adjustable leg 154 includes an alternate interlocking feature 158. This alternate interlocking feature 158 includes a spring-loaded release button 162 that allows the adjustable leg 154 to move up and own relative to the outer housing 118 when depressed. In this version, the release button 162 may be combined with a spring-loaded pivot arm 157, which includes an end portion 166 configured to engage one of a series of vertically-arranged notches 164, as shown. Pressing the release button 162 pivots the end portion 166 away from the engaged notch 164 allowing the user to slide the adjustable leg 154 up and down relative to the housing. When the adjustable leg 154 is located at a selected position, the user releases the button to re-engage the end portion 166 in a higher or lower notch 164, thereby locking the position of the adjustable leg 154 at the new position. Upon reading this specification, it should be appreciated that, under appropriate circumstances, considering such issues as user preferences, design preference, structural requirements, marketing preferences, cost, available materials, technological advances, etc., other adjustment arrangements such as, for example, threaded shafts/thumb turns, attachable base segments, replaceable legs of differing heights, cam locks, detent/aperture locks, etc., may be sufficient.

The adjustable legs 154 of the support frame 108 may include an enlarged base portion 110 arranged to stabilize the support frame 108 on a table or other supportive surface 107 during use. Each base portion 110 may include a set of resilient feet 168 design to increase stability and to protect the supportive surface 107 on which the device is placed.

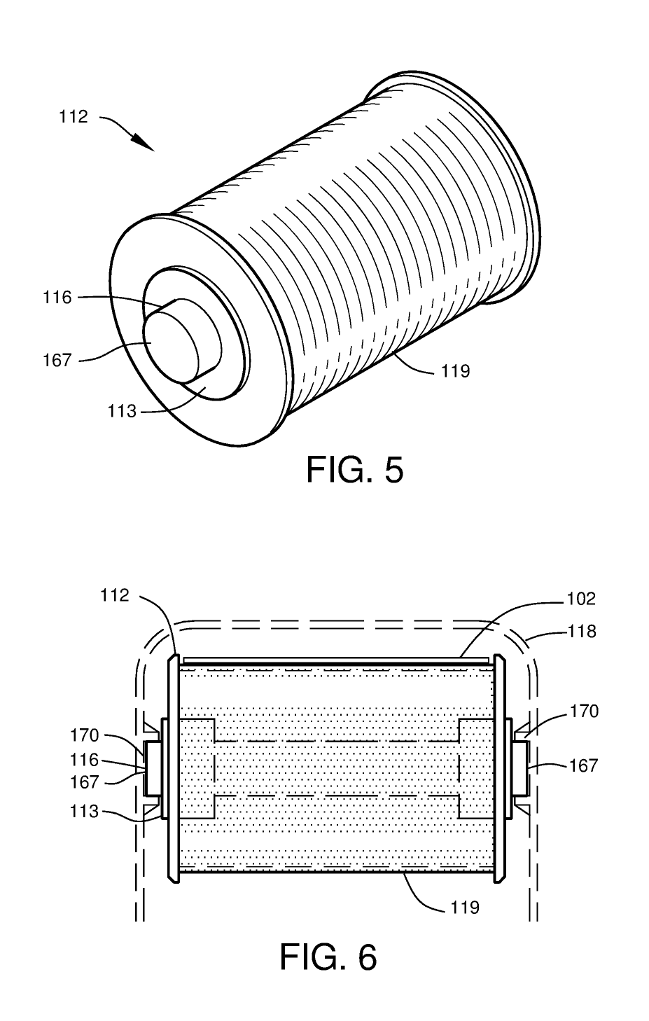

FIG. 5 is a perspective view of a guide roller 112 of the chin massage device, according to an embodiment of the disclosure. FIG. 6 is a diagrammatic sectional view showing the guide roller of the chin massage device of FIG. 1, according to an embodiment of the present disclosure. Each guide roller 112 may include a central shaft 116 having end portions 167 projecting from each side of the roller. The central shaft 116 engages a receiving socket 170 of the support frame 108, as shown. In addition, each guide roller 112 may include at least one friction-reducing bearing 113 arranged to reduce rolling resistance of the guide roller 112 during use. The guide rollers 112 may include a metal or plastic sleeve with an outer rubber surface 119.

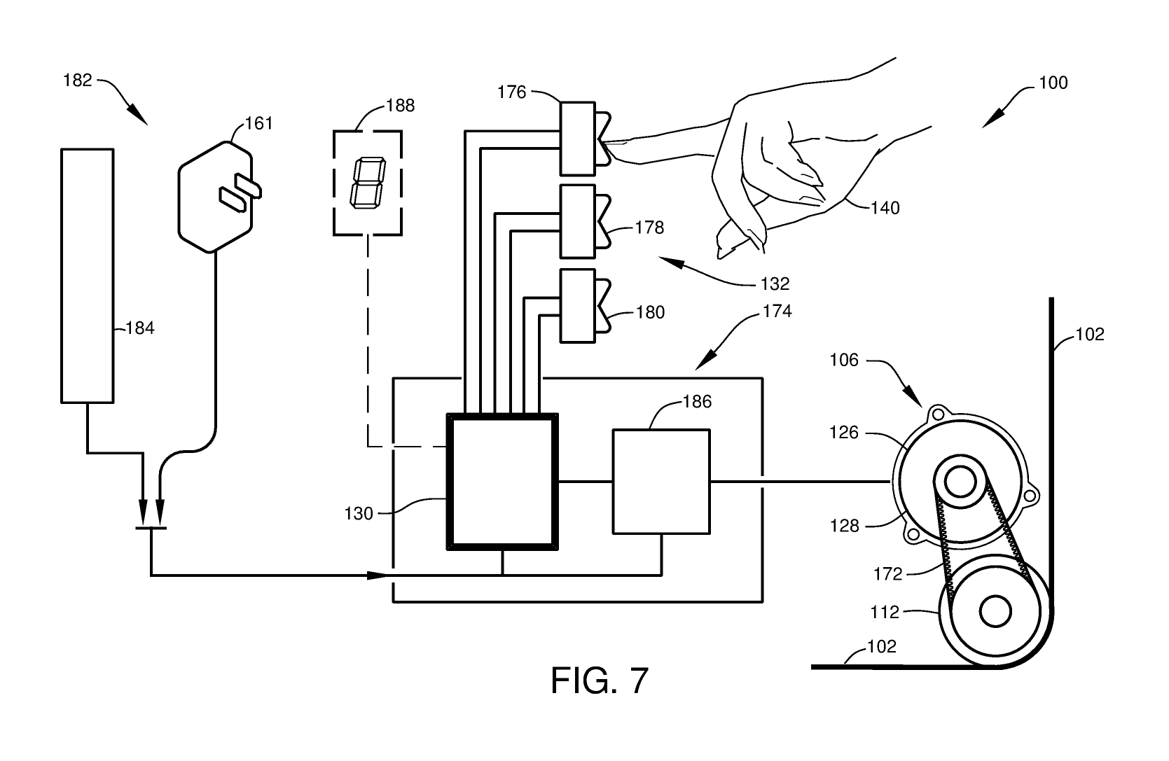

Referring again to the sectional view of FIG. 4, the electrically-powered driver 106 of the chin massage device 100 may be supplied as a reversible direct-current electric motor 126, which may be arranged move the flexible belt 102 by rotating at least one guide roller 112 of the set of guide rollers 112. The reversible direct-current electric motor 126 may be coupled to the guide roller 112 using a drive belt 172, as shown. The drive belt 172 may be of a sprocket-engagement type to increase the level of the torque force which may be transferred between the motor and roller assembly. Alternately, the drive belt may have a smooth surface to allow the drive belt to slip and come to a stop should there be an excessive load on the belt caused by an obstruction in one of the rollers. In preferred embodiments of the present disclosure, the reversible direct-current electric motor 126 may be a stepping-type electric motor 128, as generally described in FIG. 7.

FIG. 7 is a schematic diagram, illustrating operation and control features 174 of the chin massage device 100. The reversible stepping-type electric motor 128 driving the flexible belt 102 in forward and reverse directions may be controlled by a micro-controller 130 via the stepper-motor driver 186. The micro-controller 130 is arranged to control the operation of the stepping-type electric motor 128 by implementing an appropriate algorithm stored in the memory of the micro-controller 130. This arrangement may include step-drive pattern data for step driving the stepping-type electric motor 128 in the forward and reverse directions. The algorithm may be configured to control the number and frequency of step-pulse signals supplied to the stepping-type electric motor 128. For example, increasing the frequency of step-pulse signals supplied to the motor is associated with an increase in belt speed. Reducing the frequency of the step-pulse signals supplied to the motor is associated with a decrease in belt speed. Similarly, increasing the number of step-pulse signals supplied to the stepping-type electric motor 128 during each forward cycle and reverse cycle is associated with an increase in belt distance travel. Decreasing the number of step-pulse signals supplied to the stepping-type electric motor 128 during each forward and reverse cycle is associated with a decrease in belt distance travel.

The micro-controller 130 may include at least one user interface 129 allowing the user to interact with the device (see also FIG. 1 through FIG. 4). The user interface 129 may include at least one user control 132 arranged to allow the user 140 to control at least one operational parameter of the stepping-type electric motor 128. For example, the user control 132 may include an on-off button 176 allowing the user 140 to initiate and terminate operation of the device. In addition, the user control 132 may include a speed control button 178 allowing the user 140 to select a movement speed for the flexible belt 102. The user control 132 may also include a belt-travel-distance control button 180 allowing the user 140 to select the how far the belt moves in each direction. It is further noted that a standard DC motor switched by, for example, a MOSFET-based transistor control assembly may be used as an alternate option. Those with ordinary skill in the art will now appreciate that upon reading this specification and by their understanding the art of electronics and motor control as described herein, methods of implementing such motor controls will be understood by those knowledgeable in such art.

The micro-controller 130 may optionally include at least one user-discernable indicator 188 arranged to indicate at least one operational parameter of the chin massage device 100. The user-discernable indicator 188 may include an LED seven-segment display, as shown. Upon reading this specification, it should be appreciated that, under appropriate circumstances, considering such issues as user preferences, design preference, structural requirements, marketing preferences, cost, available materials, technological advances, etc., other user-discernable indicators such as, for example, OLED displays, audio indicators, etc., may be sufficient.

In some embodiments of the apparatus, the micro-controller 130 may include a clock function adapted to display a time or duration of operation on the user-discernable indicator 188. In some embodiments of the device, the micro-controller 130 may include a timer function to allow the user to set a predetermined time period for operation of the device. In this arrangement, the user may input or select the operational duration using the user interface 129.

In some embodiments of the device, the algorithm stored in the memory of the micro-controller 130 may include one or more preconfigured belt-operation programs. Such belt-operation programs may be configured to control one or more operational characteristics of the belt 102. For example, a belt-operation program may automatically alter the speed, travel distance, or duration of operation during use. In some embodiments of the device, the belt-operation programs may be selectable by the user from a set of belt-operation programs. In some embodiments of the device, the belt-operation programs may be modified or generated by the user via the user interface 129.

In some embodiments of the device, the micro-controller 130 may include a protective monitoring function designed to stop the belt in the event that something is caught in the rollers. The protective monitoring function may monitor for a motor overcurrent condition and terminate operation of the motor when an overcurrent above a predetermined threshold is detected. Upon reading this specification, it should be appreciated that, under appropriate circumstances, considering such issues as user preferences, design preference, safety requirements, cost, available materials, technological advances, etc., other safety arrangements such as, for example, using optical sensors, active torque-sensing disconnects, passive torque-sensing disconnects, etc., may be sufficient.

The chin massage device 100 may further comprise at least one low-voltage power supply 182. The low-voltage power supply 182 may include at least one on-board rechargeable battery 184. Rechargeable batteries suitable for use in the present device include rechargeable lithium batteries. Alternately, the low-voltage power supply 182 may be an external power supply 161 to convert line-voltage alternating current to low voltage direct current.

According to one embodiment, the chin massage device 100 may be arranged as a kit 105, as illustrated in FIG. 1. In particular, the chin massage device 100 may further include a set of instructions 155. The instructions 155 may detail functional relationships in relation to the structure of the chin massage device 100 (such that the chin massage device 100 can be used, maintained, or the like, in a preferred manner).

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A chin massage device relating to the manipulation of internal tissues of an under-chin area of a user, the massage device comprising:
a flexible belt configured to manipulate the internal tissues of the under-chin area by externally engaging the under-chin area of the user;
a reciprocating-belt mover configured to move the flexible belt in forward and reverse directions during external engagement of the under-chin area via the flexible belt;
an electrically-powered driver configured to drive the reciprocating-belt mover; and
a support frame configured to support the flexible belt, the reciprocating-belt mover, and the electrically-powered driver in an operable relationship, the support frame having a base portion configured to stabilize the support frame on a supportive surface during use.

2. The chin massage device of claim 1, wherein the reciprocating-belt mover is configured to move the flexible belt a distance of at least one inch.

3. The chin massage device of claim 1, wherein the reciprocating-belt mover comprises a set of guide rollers configured to supportively guide the flexible belt during the movement.

4. The chin massage device of claim 3, further comprising a belt tensioner configured to maintain the tension of the belt above a preset level.

5. The chin massage device of claim 3, wherein:
each guide roller comprises a shaft engaging the support frame; and
the chin massage device comprises at least one friction-reducing bearing configured to reduce rolling resistance of the guide roller.

6. The chin massage device of claim 3, wherein the support frame includes an outer housing structured and arranged to protectively house the guide rollers and portions of the flexible belt out of contact with the under-chin area of the user.

7. The chin massage device of claim 1, wherein the support frame comprises at least one height adjuster configured to assist user adjustments of the flexible belt to a user-preferred height relative to the supportive surface.

8. The chin massage device of claim 1, wherein the support frame comprises at least one belt-length adjuster configured to assist user adjustments to the length of a segment of the flexible belt available to externally engage the under-chin area of the user.

9. The chin massage device of claim 1, wherein the belt comprises a transverse width of at least one inch.

10. The chin massage device of claim 1, wherein the electrically-powered driver comprises a reversible direct-current electric motor.

11. The chin massage device of claim 10, wherein the flexible belt is engaged on a set of guide rollers, and the reversible direct-current electric motor is configured move the flexible belt by rotating at least one guide roller of the set.

12. The chin massage device of claim 10, wherein the reversible direct-current electric motor is a stepping-type electric motor.

13. The chin massage device of claim 12, further comprising a micro-controller configured to control the operation of the stepping-type electric motor.

14. The chin massage device of claim 13, wherein the micro-controller comprises at least one user control configured to allow the user to control at least one operational parameter of the stepping-type electric motor.

15. The chin massage device of claim 13, wherein the micro-controller comprises at least one user-discernable indicator configured to indicate at least one operational parameter of the chin massage device.

16. The chin massage device of claim 1, further comprising at least one low-voltage power supply.

17. The chin massage device of claim 16, wherein the at least one low-voltage power supply comprises at least one on-board rechargeable battery.

18. The chin massage device of claim 16, wherein the at least one low-voltage power supply is configured to convert line-voltage alternating current to low voltage direct current.

19. A chin massage device relating to the manipulation of internal tissues of an under-chin area of a user, the massage device comprising:
a flexible belt configured to manipulate the internal tissues of the under-chin area by externally engaging the under-chin area of the user;
a belt tensioner configured to maintain the tension of the belt above a preset level;
a reciprocating-belt mover configured to move the flexible belt in forward and reverse directions during external engagement of the under-chin area via the flexible belt;
an electrically-powered driver configured to drive the reciprocating-belt mover;
a support frame configured to support the flexible belt, the reciprocating-belt mover, and the electrically-powered driver in an operable relationship, the support frame having a base portion configured to stabilize the support frame on a supportive surface during use;
wherein the reciprocating-belt mover is configured to move the flexible belt a distance of at least one inch;
wherein the reciprocating-belt mover comprises a set of guide rollers configured to supportively guide the flexible belt during the movement;
wherein each guide roller comprises a shaft engaging the support frame and at least one friction-reducing bearing configured to reduce rolling resistance of the guide roller;
wherein the support frame includes an outer housing structured and arranged to protectively house the guide rollers and portions of the flexible belt out of contact with the under-chin area of the use;
wherein the support frame comprises at least one height adjuster configured to assist user adjustment of the flexible belt to a user-preferred height relative to the supportive surface;
wherein the support frame comprises at least one belt-length adjuster configured to assist user adjustments to the length of a segment of the flexible belt available to externally engage the under-chin area of the user;
wherein the belt comprises a transverse width of at least one inch;
wherein the electrically-powered driver comprises a reversible direct-current electric motor;
wherein the flexible belt is engaged on a set of guide rollers, and the reversible direct-current electric motor is configured move the flexible belt by rotating at least one guide roller of the set;
further comprising a micro-controller configured to control the operation of the reversible direct-current electric motor;
wherein the micro-controller comprises at least one user control configured to allow the user to control at least one operational parameter of the stepping-type electric motor;
further comprising at least one low-voltage power supply;
wherein the at least one low-voltage power supply comprises at least one member of the set consisting of an on-board rechargeable battery and at least one low-voltage power supply configured to convert line-voltage alternating current to low voltage direct current.

20. The chin massage device of claim 19, further comprising set of instructions; and
wherein the chin massage device is arranged as a kit.
